(19) United States
(12) Patent Application Publication
(10) Pub. No.: US 2020/0168061 A1
(43) Pub. Date: May 28, 2020

(54) METHOD AND DEVICE FOR DETECTING INTRUSIONS

(71) Applicants: Damien Koblensky, Brooklyn, NY (US); Dimitri Page, Berlin (DE)

(72) Inventors: Damien Koblensky, Brooklyn, NY (US); Dimitri Page, Paris (FR); Alfonso Desiderio, (US)

(21) Appl. No.: 16/628,149

(22) PCT Filed: Jul. 2, 2018
(86) PCT No.: PCT/EP2018/067767

§ 371 Date: Jan. 2, 2020

(30) Foreign Application Priority Data
Jul. 5, 2017 (FR) 1756350

(51) Int. Cl. G08B 13/06

(52) U.S. Cl. CPC G08B 13/06

(57) ABSTRACT

A method for detecting intrusions in a space closed by a closure device, using an intrusion detection device including at least one capacitive sensor, reacting to the introduction and/or to the contact of a person or of an object with a part of the closure device and/or to the proximity of a person, and an acquisition and analysis system, in which the acquisition and analysis system compares the trend of the response of the sensor upon the introduction and/or the contact of a person or of an object to reference data concerning the trend of the response of the sensor as a function of various actions on or in proximity to the closure device, and determines, as a function at least of the result of this comparison, whether or not there is intrusion.

The present invention relates to a method and a device for detecting intrusions in a space closed by a closure device, in order notably to trigger a warning action and/or appropriate protection.

The application US 2014/0157842 describes an electronic lock including an RFID circuit for entering an access code and a proximity sensor detecting whether an individual is present within the perimeter of the RFID circuit.

The application FR 2 892 549 describes the use of a motion sensor disposed in the central unit of an alarm, configured to determine if the central unit is displaced or jolted in order to deactivate the alarm fraudulently, the values measured by the sensor being compared to values predetermined from experience, in order to trigger an alarm in case of unauthorized motion.

It is known practice, in systems using capacitance sensors, to measure and monitor a variation of capacitance in order to obtain information that is useful for detecting an event, such as a motion in proximity. Each electronic circuit in fact generally has a stray capacitance of low value and that is sensitive to a certain number of physical parameters. Variations of the capacitance of a capacitive sensor can be caused by a temporary contact, direct or indirect, of this sensor with a human being or any object.

The application US 2015/0315815 discloses a break-in detection method using a capacitive proximity sensor and consisting in determining if the value of a measured stray capacitance lies within an authorized range of values.

There is a need to further refine the detection of intrusions through a capacitive sensor.

The aim of the invention is to address this need and it achieves this, according to one of its aspects, by virtue of a method for detecting intrusions in a space closed by a closure device, in order notably to trigger a warning action and/or appropriate protection, using an intrusion detection device comprising at least one capacitive sensor, reacting to the introduction and/or to the contact of a person or of an object with a part of the closure device and/or to the proximity of a person, and an acquisition and analysis system, method in which the acquisition and analysis system:
compares the trend of the response of the sensor upon the introduction and/or the contact of a person or of an object to reference data concerning the trend of the response of the sensor as a function of various actions on or in proximity to the closure device, and
determines, as a function at least of the result of this comparison, whether or not there is intrusion.

By virtue of the invention, a trend of the response of the sensor as a function of time is evaluated and compared to a predefined trend of reference data corresponding to several closure device usage scenarios.

It is thus possible to discriminate between a normal action on the closure device, using a key for example, and an undesirable or suspicious action, such as a lock-picking attempt, using the analysis of the trend of the response of the sensor with respect to the reference data.

An “object” is understood to be any object that can be used to open or force a door such as, for example, a key, a lock-picking tool, a screwdriver, a plastic film, a bank card, an x-ray or a crowbar.

The closure device preferably comprises a door equipped with a handle and a lock.

### Capacitance Sensor

According to an advantageous feature, the capacitive sensor is connected to at least one electrically insulated metal part of the closure device, notably a part of a lock and/or of a handle and/or of a door, the capacitive sensor reacting following variations of the capacitance of said metal part when the latter enters into contact with an object or a person.

Any action on the closure device causes the measured value of the capacitance to vary. A same action, when repeated, generates similar values or variations following the same trend, which makes it possible to obtain reliable and comprehensive reference data.

### Reference Data

Preferably, the reference data concern the trend, as a function of time, of the response of the sensor according to the use of the closure device, notably the introduction of a key corresponding to the closure device, or the introduction or the contact of another object whose purpose is to force the opening of the closure device.

The reference data can comprise the response of the sensor relative to the locked or open state of the closure device, notably of the lock and/or of the door, in the case where the closure device comprises a door equipped with a handle and a lock. The locked or open state of the closure device saved in the reference data corresponds to the engagement or non-engagement of the bolt of the lock in the keeper, said bolt being thus detected or not detected by the sensor.

The reference data can comprise the trend of the response of the sensor when an intruder tries to force the closure device with or without a specific tool, for example by introducing an x-ray into the slit of the door to move the bolt, or by introducing into the lock a key that does not correspond to the closure device, or an object other than a key, or by trying to force the door with a crowbar for example, or by drilling the lock with a drill, or by causing the lock to melt with a syringe containing acid or by a high temperature.

The reference data are preferably saved in the form of one or more tables of variations of capacitance values as a function of time, the trend of the response of the sensor according to the use of the closure device being compared to these reference data.

The capacitance values can be analyzed in the spectral domain, notably by a Fourier transform. The capacitance values can thus be expressed as a function of frequency.

The parameters to be taken into account for the analysis of such tables can be variations in absolute value, the rate of the variations as a function of time or according to frequency, the frequency of the variations, the duration of the variation indicating the duration of the action.

Preferably, variations of meteorological parameters, notably of temperature and of humidity, are taken into account in the measurement of the reference data and of the trend of the response of the sensor, such variations notably influencing the capacitance values. The variations devolving therefrom are preferably disregarded in the measurement of the reference data and of the trend of the response of the sensor. That makes it possible to have more realistic capacitance measurements.

According to an advantageous feature, trends of the response of the sensor are added to the reference data in the course of the use of the intrusion detection device, in the case of forced or unforced openings of the closure device, in order to improve the detection and the analysis of the intrusions. An updating of the acquisition and analysis system is thus ensured, through learning in the course of the use of the device, making it possible to render the intrusion detection more effective and more reliable.

### Analysis and Detection

Preferably, the acquisition and analysis system determines that there is intrusion in the closed space when the variations of capacitance with respect to the reference data, for a predefined duration, correspond to an abnormal activity. The predefined duration can be determined either by an algorithm or from the reference data.

At least one warning and/or one protection system can be triggered when the acquisition and analysis system determines that there is intrusion in the closed space. This can be an alarm, notably in the form of a light signal and/or of a sound warning, to signal an abnormal use of the closure device. An alert to a guard or a surveillance center in case of detection of an abnormal use of the closure device can also be sent. As a variant or in combination, a protection system can be triggered, for example a spraying of an unpleasant substance into the closed space, or a mechanism blocking the closure device from the inside of the closed space, such as a bar being placed across the door in order to block the opening thereof.

### Intrusion Detection Device

The invention relates also, according to another of its aspects, to a device for detecting intrusions in a space closed by a closure device, notably for implementing the method according to the invention, in order notably to trigger a warning action and/or appropriate protection, the device comprising:
at least one capacitive sensor, reacting to the introduction and/or to the contact of an object or of a person with a part of the closure device and/or to the proximity of a person, and
an acquisition and analysis system configured to compare the trend of the response of the sensor to reference data concerning the trend of the sensor as a function of various actions on or in proximity to the closure device, and determine, as a function at least of the result of this comparison, whether or not there is intrusion.

The acquisition and analysis system can comprise a microcontroller, executing an algorithm for implementing the intrusion detection method according to the invention.

Preferably, the intrusion detection device according to the invention has access to a memory containing the reference data, saved notably in the form of a table of variations of capacitance values as a function of time. This memory can also contain information for different types of actions to be executed such as contacting the guard or calling the surveillance center in case of intrusion, as appropriate.

The intrusion detection device can comprise this memory. In a variant, the intrusion detection device accesses the memory via a remote server, for example by a wired or wireless link, notably of Wi-fi or Bluetooth® type.

The intrusion detection device advantageously comprises a detector of variations of physical parameters, notably of temperature and/or of humidity, recording variations of meteorological parameters.

The detector of variations of physical parameters can advantageously be placed inside the closed space, so as to detect variations due to an intrusion, for example in case of the opening of a window.

According to an advantageous feature, the intrusion detection device is configured to trigger an alarm in the form of a light signal and/or a sound warning via a loudspeaker, to signal an intrusion if an abnormal use of the closure device is detected. The alarm can be deactivated or activated, for example when the user goes away on vacation.

The intrusion detection device can comprise several capacitance sensors, including at least one proximity sensor. Thus, by placing several sensors at several points of the door or outside, for example in the form of antennas, it is possible to detect the variation of capacitive values through the proximity of an individual and check whether the presence thereof is prolonged, therefore abnormal. Moreover, each sensor can be configured to ensure a certain functionality, for example one sensor can be configured to detect the touching of the lock and another to sense proximity.

The intrusion detection device according to the invention can be deactivated for a certain period of time, for example in the case where the door is to be crossed very regularly, for example in the case of a reception with a number of invitees, or leave open for a certain time, for example while unloading shopping or luggage.

Preferably, the intrusion detection device is situated inside the closed space, being notably incorporated in the lock or in the rabbet of the door or of the door jamb. It can thus not be destroyed through ill-intent.

The features described above in relation to the method apply also to the device, and vice versa.

### DETAILED DESCRIPTION

The invention will be able to be better understood on reading the following detailed description, of nonlimiting examples of implementation thereof, and on studying the attached drawing, in which:

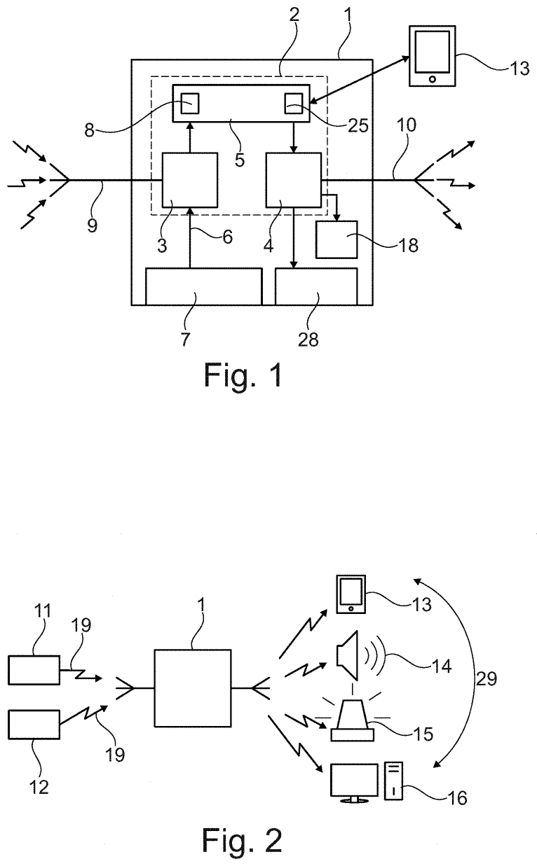

FIGS. 1 and 2 represent, schematically, an intrusion detection device according to the invention in its environment of use interacting with other devices, and

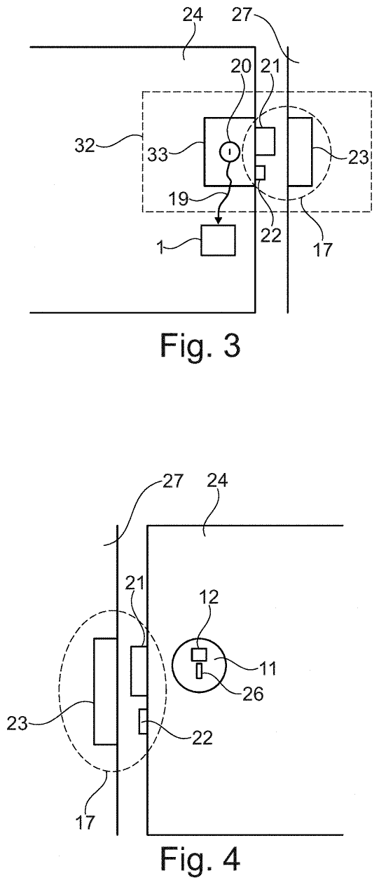

FIGS. 3 and 4 illustrate, schematically, a closure device seen from the inside of the closed space and from the outside thereof, respectively.

FIG. 1 represents an intrusion detection device 1 according to the invention, receiving capacitive signals 9 and transmitting alarm signals 10.

In this example, the intrusion detection device 1 comprises an acquisition and analysis system 2 receiving a capacitive signal 6 from capacitive sensors 7 internal to the device 1. The capacitive sensors 7 are physically connected to the acquisition and analysis system 2 by a wired link.

The acquisition and analysis system 2 preferably comprises a module 3 for receiving capacitive signals 9 and 6, a module 4 for transmitting alarm signals and an analysis module 5 being composed of a central unit which comprises a microcontroller 8 and a memory 25.

In the example considered, the intrusion detection device 1 also comprises an internal audio transmitter 18, notably a loudspeaker, and a light signal transmitter 28 linked to the module 4 for transmitting alarm signals by a wired link.

The central unit 5 can be connected by a wireless link to a personal mobile device 13, notably a smartphone, that can serve as wireless transceiver.

The central unit 5 is configured, notably through an algorithm executed on the microcontroller 8, to compare, in conditions of use of the lock, the trend of the capacitance values measured as a function of time to reference data.

The algorithm executed on the microcontroller 8 can comprise the following steps:
searching for variations on the sensors at each sampling interval Δₜ;
if ((Sⱼ>Bₛ) or (Pₙ>Bₚ)), in which Sⱼ is a capacitance value of the capacitive sensor j, Pₙ is the capacitance value of capacitive proximity sensor n, Bₛ is the reference threshold for the capacitive sensors and Bₚ is the reference threshold for the capacitive proximity sensors, then given

$$t = \frac{{Δ}_{D}}{{Δ}_{t}}$$

in which Δₜ is the sampling interval, for example equal to 0.1 second, and Δ_{D} is the interval within which the closure device is in the alert state and under analysis, for example equal to 30 seconds, calculating the following value, on each iteration i:

$${A}_{SP} = \vert \frac{{\sum }_{i = 0}^{w} ( ( \frac{1}{k} {\sum }_{j = 0}^{k - 1} {S}_{j} σ ) + ( \frac{1}{y} {\sum }_{n = 0}^{y - 1} {P}_{n} ψ ) )}{w} \vert$$

w being the number of calculation iterations in the alert state, in which (i≤w≤t−1),
k being the number of capacitive sensors j, with j from 0 to k−1,
y being the number of capacitive proximity sensors n, n from 0 to y−1,
σ and ψ being weighting coefficients of the different sensors,
if A_{SP}>I, in which I is a predefined threshold value, then an alarm is triggered.

The memory 25 advantageously contains reference data in the form of variations of values of the capacitances of the sensors 7 corresponding to different scenarios of use of the lock and saved in the form of tables of capacitance trending as a function of time.

The reference data corresponding to a state of the closure device can be selected at least from among:
door open;
door closed;
door locked with a key;
door locked with a key remaining in contact with a person;
door opened with a key remaining in contact with a person; and
door opened with a key.

These states are given purely by way of example. Other states can be evaluated, such as the opening of a door by a tool other than a key, or a manipulation of the lock with one hand or a kick to the door causing the bolt of the lock to move, etc.

These reference data are acquired during the installation of the intrusion detection device 1 on the closure device. When the device 1 is placed on the closure device, the device 1 is initialized by saving the capacitance values corresponding to the “open”, “closed” and “locked” states, as well as the variation of the capacitance when the closure device is opened conventionally with its key. The reference data corresponding to a suspicious use of a closure device can also be saved beforehand in the memory, different tests and scenarios having been carried out, for example in a laboratory, to identify different suspicious uses.

In an exemplary implementation of the intrusion detection method according to the invention, values representing the trend of the response of the sensors 7, 11, 12 in an actual use of the closure device are compared to the reference data.

In the case of a trend of the response of the sensors 7, 11, 12 corresponding to a use of the lock that is deemed normal, a “the door is open” notification can be sent by the acquisition and analysis system 2 but no notification to trigger an alarm is sent.

The acquisition and analysis system 2 determines that there is intrusion in the closed space when the central unit 5, by analyzing the variations of capacitance for a predefined duration, determines that there are variations with respect to the reference data corresponding to an abnormal activity.

In the example described, the loudspeaker 18 triggers an alarm to signal an intrusion if an abnormal use of the lock is detected.

The mobile device 13 can be connected to an interne or intranet network to receive and transmit updates. The mobile device 13 can also send an alert to a guard or a surveillance center in the case of detection of an abnormal use of the lock.

The acquisition and analysis system 2 can comprise a detector of variations of physical parameters, in particular of temperature and of humidity, as in the example considered.

In the variant of FIG. 2, the intrusion detection device 1 is connected by a cable 19 to a capacitive sensor 11 and a capacitive sensor 12 that is configured for proximity detection.

The intrusion detection device 1 can also be connected by a wireless or wired link to an audio transmitter 14, a transmitter of light notifications 15 and a centralized alarm management service 16.

The personal mobile device 13, the audio transmitter 14, the transmitter of light notifications 15 and the centralized alarm management service 16 can communicate with one another via a bidirectional communication 29.

In FIG. 3, the intrusion detection device 1 according to the invention is represented connected to a closure device 32 comprising a door 24 and a lock 17, seen from the interior of the closed space.

The lock 17 comprises a housing 33 provided with a latch 21 and a bolt 22, and a keeper 23 located in the door frame 27.

The door 24 is closed conventionally when the latch 21 is inserted into the keeper 23, and it is unlocked by turning the appropriate key one or more times in the barrel 20.

The capacitive sensors 7, 11, 12 of the device 1 are preferably connected to a metal part of the closure device 32, notably to a metal part of the housing 33, for example on the barrel 20 at the key entry by a cable 19, as can be seen in FIG. 3. In a variant, the intrusion detection device 1 comprises a recess configured for the insertion of the metal rod of the barrel 20 situated below the key entry.

In FIG. 4, which is a view of the outside of the closure device, the key is inserted into the slot 26. A capacitive sensor 11 and a capacitive proximity detection sensor 12 are connected to the door 24.

Obviously, the invention is not limited to the examples which have just been described.

The intrusion detection device can be used for any closed space, a private residence for example, but also for a cupboard, a container, a safe, and for a space closed by any closure device, for example that is opened with a key, comprising a code keypad or being opened with an electronic card.

1. A method for detecting intrusions in a space closed by a closure device using an intrusion detection device comprising at least one capacitive sensor, reacting to the introduction and/or to the contact of a person and/or of an object with a part of the closure device and/or to the proximity of a person, and an acquisition and analysis system, method in which the acquisition and analysis system:
compares the trend of the response of the sensor, upon the introduction and/or the contact of a person and/or of an object and/or to the proximity of a person, to reference data concerning the trend of the response of the sensor as a function of various actions on or in proximity to the closure device, depending on the use thereof, and
determines, as a function at least of the result of this comparison, whether or not there is intrusion.

2. The method as claimed in claim 1, wherein the reference data concern the trend, as a function of time, of the response of the sensor according to the use of the closure device, or the introduction or the contact of another object whose purpose is to force the opening of the closure device.

3. The method as claimed in claim 1, wherein the capacitive sensor is connected to at least one metal part of the closure device, the capacitive sensor reacting following variations of the capacitance of said metal part when the latter enters into contact with an object or a person.

4. The method as claimed in claim 1, wherein the acquisition and analysis system determines that there is intrusion in the closed space when the variations of capacitance relative to the reference data, for a predefined duration, correspond to an abnormal activity.

5. The method as claimed in claim 1, wherein at least one warning and/or one protection system is triggered when the acquisition and analysis system determines that there is intrusion in the closed space, to signal an abnormal use of the closure device.

6. The method as claimed in claim 1, wherein trends in the response of the sensor are added to the reference data in the course of the use of the intrusion detection device, in the case of forced or unforced openings of the closure device, in order to improve the detection and the analysis of the intrusions.

7. The method as claimed in claim 1, wherein variations of meteorological parameters are taken into account in the measurement of the reference data and of the trend of the response of the sensor.

8. A device for detecting intrusions in a space closed by a closure device, the device comprising:
at least one capacitive sensor, reacting to the introduction and/or to the contact of an object and/or of a person with a part of the closure device and/or to the proximity of a person, and
an acquisition and analysis system configured to compare the trend of the response of the sensor to reference data concerning the trend of the response of the sensor as a function of various actions on or in proximity to the closure device, and determine, as a function at least of the result of this comparison, whether or not there is intrusion.

9. The device as claimed in claim 8, having access to a memory containing the reference data, the trend of the response of the sensor according to the use of the closure device being compared to these reference data.

10. The device as claimed in claim 8, configured to trigger an alarm and/or a personal mobile device and/or a centralized alarm management service, to signal an intrusion if an abnormal use of the closure device is detected.

11. The device as claimed in claim 8, comprising a detector of variations of physical parameters.

12. The device as claimed in claim 8, comprising several capacitive sensors, including at least one proximity sensor.

13. The device as claimed in claim 8, being situated inside the closed space.
